(19) United States
(12) Patent Application Publication
(10) Pub. No.: US 2004/0100421 A1
(43) Pub. Date: May 27, 2004

(54) Method and apparatus for correcting errors in displays

(76) Inventors: James R. Webb, Kamuela, HI (US); Steve Selby, Scarborough (CA); Gheorghe Berbecel, Richmond Hill (CA)

Correspondence Address: MERCHANT & GOULD PC, P.O. BOX 2903, MINNEAPOLIS, MN, 55402-0903, US

(21) Appl. No.: 10/240,887

(22) PCT Filed: Apr. 5, 2001
(86) PCT No.: PCT/US01/11293

(51) Int. Cl. G09G 1/06

(52) U.S. Cl. 345/10

(57) ABSTRACT

A system for enhancing brightness and resolution while correcting certain types of convergence, geometry, color and luminance errors caused by the display device, the viewing position or both. This system involves merging images from two or more sources, overlapping and offsetting pixels, or overlapping scanning lines “merged raster” in a CRT or several (3) “merged rasters” in color CRT's, and adjusting video content and timing, to compensate for the current viewing position and/or device distortion. Display and/or viewing perspective distortion characteristics are measured from the observers viewing position for the raster or each non-converged raster and stored as correction factor data in non-volatile memory. This data is used to modify the digital addressing of video image memory, to read and to correct pixel data for each image, adjust color, modify magnitude, and to drive the displays video amplifier at the correct time with the corrected amplitude and image data. Making these changes within the video path provides substantial improvements in image quality and in cost savings.

### RELATED APPLICATIONS

This application claims priority of U.S. provisional application Serial No. 60/194,620 filed Apr. 5, 2000.

This application is being filed as a PCT application by GENESIS MICROCHIP, INC. a Canadian national and United States resident, as applicant for Europe, Japan, Republic of Korea; AND James R. Webb, United States national and resident, Steve Selby, Canadian national and resident and Gheorghe Berbecel, Canadian national and resident as applicants/inventors for United States only. This PCT application designates Europe, Japan, Republic of Korea and United States.

### FIELD OF THE INVENTION

The present invention pertans to video displays and more particularly to enhancing brightness and resolution and correcting certain types of errors caused by display devices.

### DEFINITIONS

ALIGN means to cause a video image to be adjusted so that distortion characteristics are minimized and the video image that is displayed on the cathode ray tube forms an image that is pleasing to the eye.

ALIGNMENT CAMERA means the video used to generate a signal that is representative of the image displayed on the cathode ray tube in a manner described in U.S. Pat. No. 5,216,504.

ALIGNMENT SPECIFICATIONS means a limit set for the distortion data of each correction factor parameter to provide an aligned video image.

BAR CODE means any sort of optically encoded data.

CATHODE RAY TUBE (CRT) means the tube structure, the phosphor screen, the neck of the tube, the deflection and control windings, including the yoke and other coils, and the electron guns.

CHARACTERIZATION MODULE means a device that is coupled in some manner to a display device and may include a storage device for storing correction factor data or an identification number for the display device, and/or a processing device such as a microprocessor or other logic device, and/or driver and correction circuits, and/or control circuitry. The characterization module can also store parametric data for use in aligning monitors that employ standardized transformation equations.

COORDINATE LOCATIONS means the discrete physical locations on the face of the cathode ray tube, or a physical area on the display screen.

CORRECTION AND DRIVER CIRCUITRY means one or more of the following: digital to analog converters, interpolation engine, pulse width modulators and pulse density modulators, as well as various summing amplifiers, if required. These devices are capable of producing correction control signals that are applied to control circuitry to generate an aligned video image.

CORRECTION CONTROL SIGNALS means correction factor signals that have been combined in a manner to be applied to either horizontal control circuitry, vertical control circuitry, or electron gun circuitry.

CORRECTION FACTOR DATA comprises the encoded digital bytes or any other form of data that are representative of the amount of correction required to align a video signal at a particular physical location on a cathode ray tube to counteract distortion characteristics at that location. Correction factor data may include data from the gain matrix table, data relating to electron gun characteristics and/or data relating to geometry characteristics of the cathode ray tube.

CORRECTION FACTOR PARAMETERS include various geometry characteristics of the cathode ray tube including horizontal size, vertical size, horizontal center, vertical center, pin cushion, vertical linearity, keystone, convergence, etc., and various electron gun characteristics of the cathode ray tube including contrast, brightness, luminosity, focus, color balance, color temperature, electron gun cutoff, etc.

CORRECTION FACTOR SIGNALS means digital correction signals that have been integrated or filtered.

CORRECTION SIGNALS means digital correction signals and correction factor signals.

DECODER means a device for generating an electronic signal in response to one or more data bytes that may include PWMs, PDMs, DACs, interpolation engines, onscreen display chips, etc.

DIGITAL CORRECTION SIGNALS means signals that are generated by decoders, such as pulse width modulators, pulse density modulators, digital to analog converters, etc. in response to correction factor data.

DIGITAL IMAGE SIGNAL means digital data that has been processed to correct for display device artifacts.

DIGITIZED SIGNAL is any electrical signal that has a digital nature.

DIGITIZED VIDEO SIGNAL is an input video signal that has been sent in a digital form or converted to a digital form, that can be stored in RAM or other digital storage device and processed with digital processing devices.

DIRECTION means up, down, left, right, brighter, dimmer, higher, lower, etc.

DISCRETE LOCATIONS may mean individual pixels on a cathode ray tube screen or may comprise a plurality of pixels on a cathode ray tube screen.

DISPLAY PRODUCT means the packaged display product made for viewing video signals containing one or more display devices.

DISPLAY DEVICE means a CRT, tube and yoke assembly, LCD, DMD, Microdisplay, etc. and the associated viewing screen.

DISPLAY IMAGE SIGNAL means the corrected output video signal that drives the display device.

DISPLAY SCREEN means the surface that the video image is viewed.

DISTORTION CHARACTERISTICS means the amount of distortion as indicated by the distortion data at a number of different points on the cathode ray tube.

DISTORTION DATA is a measure of the amount of distortion that exists on a display with regard to the geometry characteristics of the display device, and/or transfer characteristics of the display device. For example, distortion data can be measured as a result of misalignment of a video image or improper amplitude or gain of a video image signal. Distortion data can be a quantitative measure of the deviation of correction factor parameters from a desired quantitative value. Distortion data can be measured at coordinate locations on the display device.

DRIVER SIGNALS are the electrical signals that are used to drive the deflection and control windings, and electron guns of the cathode ray tube, display image signal, and the addressing data for a pixilated display.

EXIT CRITERIA means a limit set for the distortion data of each correction factor parameter that allows generation of correction factor data that is capable of producing an aligned video image.

FRAME GRABBER means an electronic device for capturing a video frame.

GAIN MATRIX TABLE means a table of values that are used to indicate how a change in correction factor data for one correction factor parameter influences the change in the correction factor data for other correction factor parameters, as disclosed in U.S. patent application Ser. No. 08/611,098, filed Mar. 5, 1996, entitled “Method and Apparatus for Making Corrections in a Video Monitor.”

GOLDEN TUBE/DISPLAY means a sample display device having limit distortion characteristics for a particular model of display device.

INTEGRATORS means a device for generating an integrated signal that is the time integral of an input signal.

INTERPOLATION ENGINE means a device for generating continuously variable signals, such as disclosed in U.S. patent application Ser. No. 08/613,902 filed Mar. 11, 1996, U.S. Pat. No. 5,739,870, by Ron C. Simpson entitled “Interpolation Engine for Generating Gradients.”

LOGIC DEVICE means any desired device for reading the correction factor data from a memory and transmitting it to correction and driver circuitry, including a microprocessor, a state machine, or other logic devices.

MAGNETIC STRIP means any sort of magnetic storage medium that can be attached to a display device.

MAXIMUM CORRECTABLE DISTORTION DATA means the limits of the distortion data for which an aligned video signal can be generated for any particular display device using predetermined correction and driver circuitry, and control circuitry.

MEMORY comprises any desired storage medium including, but not limited to, EEPROMs, RAM, EPROMs, PROMs, ROMs, magnetic storage, magnetic floppies, bar codes, serial EEPROMs, flash memory, etc.

MULTI-MODE DISPLAY means a multi-sync monitor using multi-sync technology.

NON-VOLATILE ELECTRONIC STORAGE DEVICE means an electrical memory device that is capable of storing data that does not require a constant supply of power.

PATTERN GENERATOR means any type of video generator that is capable of generating a video signal that allows measurement of distortion data.

PIXILATED DISPLAY means any display having discrete picture elements; examples are liquid crystal display panels, Digital Micro-mirror Display (DMD), and Micro Displays.

PROCESSOR means a logic device including, but not limited to, serial EEPROMs, state machines, microprocessors, digital signal processors (DSPs), etc.

PRODUCTION DISPLAY DEVICE means a display device that is manufactured in volume on a production line.

PULSE DENSITY MODULATION means a device for generating pulse density modulation signals in response to one or more data bytes, such as disclosed in U.S. patent application Ser. No. 08/611,098, filed Mar. 5, 1996 by James R. Webb et al entitled “Method and Apparatus for Making corrections in a Video Monitor.”

PULSE WIDTH MODULATOR means a device that generates pulse width modulated signals in response to one or more data bytes, such as disclosed in U.S. patent application Ser. No. 08/611,098, filed Mar. 5, 1996 that is cited above and U.S. Pat. No. 5,216,504.

STORAGE DISK comprises any type of storage device for storing data including magnetic storage devices such as floppy disks, optical storage devices, magnetic tape storage devices, magneto-optical storage devices, compact disks, etc.

SUMMING AMPLIFIERS means devices that are capable of combining a plurality of input signals such as disclosed in U.S. patent application Ser. No. 08/611,098 filed Mar. 5, 1996, that is cited above.

TRANSFORMATION EQUATION means a standard form equation for producing a correction voltage waveform to correct distortion characteristics of a display device.

UNIVERSAL MONITOR BOARD means a device that includes one or more of the following: vertical control circuitry, horizontal control circuitry, electron gun control circuitry, correction and driver circuitry, a logic device and a memory. A universal monitor board may comprise an actual chassis monitor board used with a particular monitor, an ideal chassis board, a chassis board that can be adjusted to match the characteristics or specifications of a monitor board, etc.

VIDEO IMAGE means the displayed image that appears on the display device screen that is produced in response to a video signal.

VIDEO PATTERN is the video image of a pattern that appears on the viewing screen of the display device as a result of the video signal generated by the pattern generator.

VIDEO SIGNAL means the electronic signal that is input into the display product.

### DESCRIPTION OF THE BACKGROUND

In the field of video technology, conventional methods and systems for displaying video signals on video display devices have inherent characteristics that result in visual artifacts in the displayed video images. These artifacts are considered errors in the image, inasmuch as the picture intended for displaying and viewing differs from the image actually displayed and viewed. Errors arise in many types of multi-mode and pixilated video displays, including computer cathode ray tube (CRT) monitors, computer liquid crystal display (LCD) monitors, DMD projectors, Micro Displays, and high definition television (HDTV) receivers. Thus, traditional display systems and methods do not provide the best picture possible within existing standards.

One artifact common in current multi-mode and pixilated displays is less than optimal brightness and resolution. Sub-optimal brightness and resolution occurs from gaps that exist between picture elements (pixels) on the display screen. Because of the gaps, the electronic beam in the display cannot illuminate or address the entire display surface. Gaps between pixels result in what is known as low fill factor, wherein no light is emitted between pixels. The center-to-center spacing of these pixels is separate, fixed, and discrete. Low fill factor lowers potential brightness and reduces resolution resulting in jagged edges on alphanumeric characters and diagonal lines. The viewer is often aware of the spaces between lines and pixels, almost like looking at a scene through a screen door. This becomes annoying and even uncomfortable to the viewer, leading to eyestrain, fatigue, and loss of productivity. In non-pixilated displays one way of improving brightness and resolution is to merge or over-merge scan lines in the raster, so that the scan lines overlap. However, current multi-mode and pixilated displays cannot take advantage of the over-lapping characteristics of merging and over-merging scan lines because in modes that operate at pixel densities below the merged raster density there are gaps between the pixels in the image.

Displays with magnetic or electrostatic deflection of the addressing beam or beams often exhibit other forms of distortion like pincushion, keystone, and other non-linearities. These distortions are a result of the electron beam being improperly deflected across the viewing screen of the CRT. The electron beam is quite sensitive to fluctuations in the electromagnetic field through which it passes. As a result, improper deflection can occur for many reasons, including coil misadjustment and the earth's magnetic field. Traditional methods and systems have been employed to attempt to fix these distortions by using additional deflection coils and electronic circuitry in the monitor to finely adjust the position of the electron beams; however, these methods cannot compensate completely for erroneous beam deflection, and require significant additional capital expenditures for the necessary components.

FIG. 3 illustrates a display screen 300 of a cathode ray tube (CRT) display device, in which the electron beam is sweeping at a nonlinear speed. The electron beam starts out at a faster speed and slows down as it sweeps from the left side of the screen 300 to the right side of the screen. Below the display screen 300 in FIG. 3 is an illustration of a video signal 302 with video data The video data is used by the electron gun of the display device to draw straight vertical lines 304, 306, 308, and 310 on the screen 300. The video signal 102 is sending data represented by vertical pulses 312, 314, 316, 318, and 320 separated equally in time at time points 322, 324, 326, 328, and 330 respectively. The intent of the video signal 302 is to instruct the display device to draw the lines 304, 306, 308, and 310 with equal distance between them. The video signal 302 is typically output in a clocked fashion so that video data pulses 312, 114, 316, 318, and 320 are equally spaced in time. Without the affects of the nonlinearity in the speed of the electron beam, the equally timed pulses of video signal 302 would map to equally spaced lines on the screen 300. However, because of the nonlinearity of the speed of the electron gun, the video data is not displayed equally in space on the screen 300. Prior art solutions to nonlinearity involve employing complicated circuitry and coils in the display device, requiring installation and rigorous testing and retesting to fine tune the speed of the beam across the screen. However, even with the cost, time, and effort in prior art techniques, nonlinearity is still not completely fixed.

FIG. 5 illustrates left/right pin cushioning error and inner pin cushioning error in a display screen 500. Pin cushioning is the result of the physical construction of the deflection yoke, gun to screen distance, screen curvature, and the rate at which the electron beam is deflected across the display screen. Below the screen 500 is a representation of a video signal 502 having video data in the form of vertical pulses 504, 506, 508, 510, and 511 equally spaced in time at times 512, 514, 516, 518, and 520, respectively. The pulses 504, 506, 508, 510, and 511 are intended to generate straight vertical lines on the screen; however, because of the pin cushioning effect of the display device, the left border line 522 and the right border line 524 are bowed inward. There is also slight inner pin cushioning of inner line 532 and inner line 534. Prior art techniques used to fix the affects of pin cushioning involve employing complicated circuitry.

FIG. 7 illustrates top/bottom pin cushioning error in a cathode ray tube (CRT). As a result of well-known inherent physical and electromechanical characteristics of typical CRTs, a top/bottom pin cushioning effect is created on the screen. Top line 700 on the screen 702 is intended to be a straight line. Similarly bottom line 704 is intended to be a straight line. Below the screen 702 is a depiction of a top scan line 706 having a downward bowed trajectory. When the electron beam of the CRT follows the bowed scan line 706 the resultant pattern on the screen 702 is not a straight, horizontal line, but rather, a bowed line 708.

FIG. 9 illustrates a misconvergence error on a CRT screen. A red raster line 900 is shown scanning from left to right across the screen. A green raster line 902 is shown scanning across the screen from left to right. The red raster line 900 is shown at a diagonal relative to the green raster line 902. This illustrates misregistration of the red raster of the CRT and the green raster of the CRT. A similarly misregistration is depicted with a red line 906 and a green line 904 at the bottom of the screen. Below the figure of the screen is an enlarged view of redline 900 sweeping adjacent to and intersecting with the green line 902. The redline 900 converges with the green line 902 only in the middle of the green line in a yellow section, 908. The pattern that was intended to be drawn upon the screen is a straight horizontal line, but because of the misregistration of the red raster of the CRT, only a small section of a horizontal yellow line is created. Furthermore, on either side of the yellow section, 908, are an unintended green line and unintended red line. Misregistration also occurs in the case of the blue raster.

In color CRT displays, including those displaying an HDTV format, three electron beams are deflected to form rasters registered upon a single viewing screen of the display. Similarly, in the case of other types of projectors, such as liquid crystal display (LCD) projectors and digital micro mirror display (DMD) projectors, three light beams are registered upon a viewing screen. When forming an image, if a CRT or projector is working correctly, the three beams converge at the same point for each point in the image. When the three beams do not converge perfectly, colored edges, or halos, appear around text and pictures in the image. Misconvergence may occur when the beams are not aimed properly at the viewing screen. Misconvergence reduces image clarity, contrast, and resolution.

Also, when interlacing is used as in a raster scanning CRT, the line structure of the display may become visible. Furthermore, in color displays, at lower resolution modes the individual raster lines are often visible as separate red, green, and blue lines with black gaps between where no light is produced.

Accordingly there is a need for a method for improving display resolution and brightness and correcting errors in displays.

### SUMMARY OF THE INVENTION

The present invention overcomes the disadvantages and limitations mentioned above by providing, in general, a system of correcting for video image errors in advance of the display device. The effective resolution and brightness of the image can be increased using merged images that overlap each area of the viewing surface with more than one position addressable illumination source. The entire viewing surface can emit light without gaps or spaces. A video signal can be over sampled to create a denser address space, corrected for display or viewing perspective distortion and enhanced to produce artifact-free video images.

The present invention preferably comprises a video signal display system for creating video images that include a display device to generate an image on a screen, which has addressable screen locations. The system also includes a digitized video signal memory storing pixel information representing a digitized video signal, and a video processor module configured to receive screen information from the display device. The screen information defines a screen parameter. The video processor module is preferably configured to map the screen parameter to an address in the image memory containing pixel information corresponding to the screen parameter.

The present invention may also comprise a characterization module having a translation data table indexable by the screen information to obtain a screen location or a time associated with a screen location. The characterization module communicates the addressable screen location to the video processor module.

The present invention may also include a method of displaying a video image by receiving information defining an addressable screen location from a display device. The method further comprises retrieving image pixel information corresponding to the addressable screen location, and driving an illumination source in the display device to illuminate the addressable screen location using the image pixel information. The method may further include loading a counter module with a time value representing when a corrected video image should be generated. The present invention may also include computer readable media having computer readable instructions for performing the method.

### BRIEF DESCRIPTION OF THE DRAWINGS

FIG. 1(a) is a schematic diagram of the system of the present invention for pre-correcting a digitized image signal in an embodiment of the present invention.

FIG. 1(b) is a schematic diagram of the system of the present invention for pre-correcting a digitized image signal in an embodiment of the present invention.

FIG. 2 is a schematic illustration of a monitor having a characterization module coupled to a video processor module that uses correction factor data to generate a pre-corrected video signal.

FIG. 3 illustrates a display screen exhibiting nonlinearity error of the scan beam as it sweeps across the screen.

FIG. 4 illustrates a display screen having a precorrected image correcting nonlinearity error shown in FIG. 3 in accordance with the present invention.

FIG. 5 illustrates a display screen exhibiting left/right pin cushioning error.

FIG. 6 illustrates a display screen having a precorrected image correcting left/right and inner pin cushioning error shown in FIG. 5 in accordance with the present invention.

FIG. 7 illustrates top/bottom pin cushioning on a display screen.

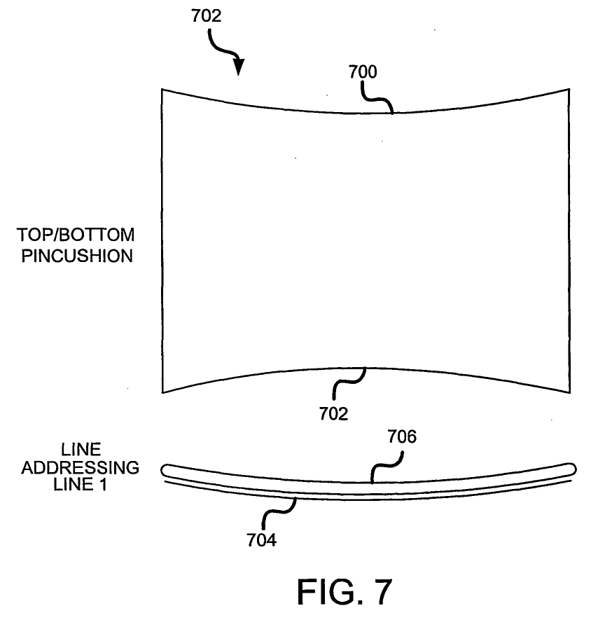

FIG. 8 illustrates a screen displaying a precorrected image correcting top/bottom pin cushioning shown in FIG. 7 in accordance with the present invention.

FIG. 9 illustrates a display screen having misconvergence error.

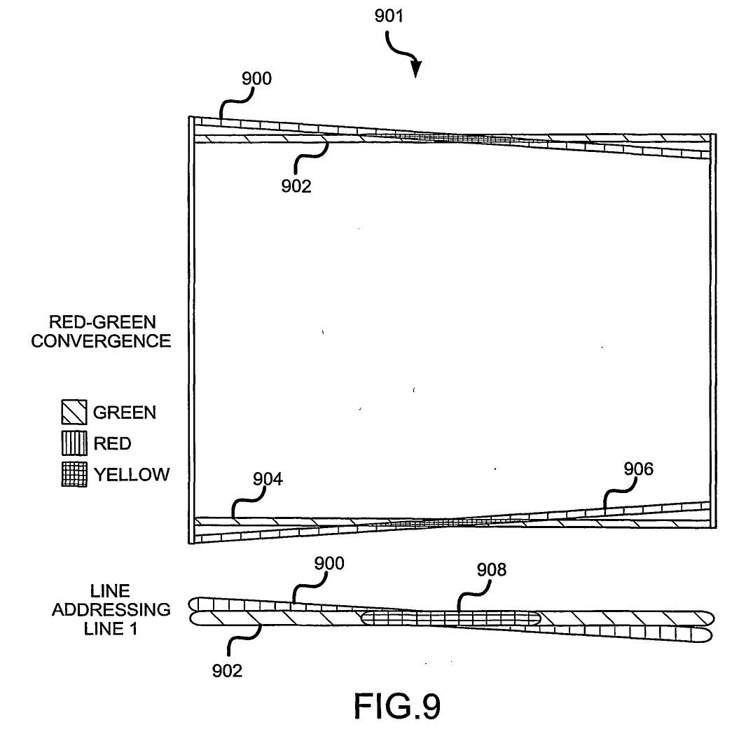

FIG. 10 illustrates a display screen displaying a precorrected image correcting misconvergence shown in FIG. 9 in accordance the present invention.

FIG. 11 is a schematic diagram of a display screen with scanning beam lines drawing an image in an exemplary embodiment of the present invention.

FIG. 12 is a schematic diagram of physical screen locations mapped to corresponding image memory addresses in the present invention.

FIG. 13 is a flow control diagram illustrating a method of precorrecting an image in accordance with an embodiment of the present invention.

### DETAILED DESCRIPTION

The invention is described in detail below with reference to the drawing figures. When referring to the figures, like structures and elements shown throughout are indicated with like reference numerals.

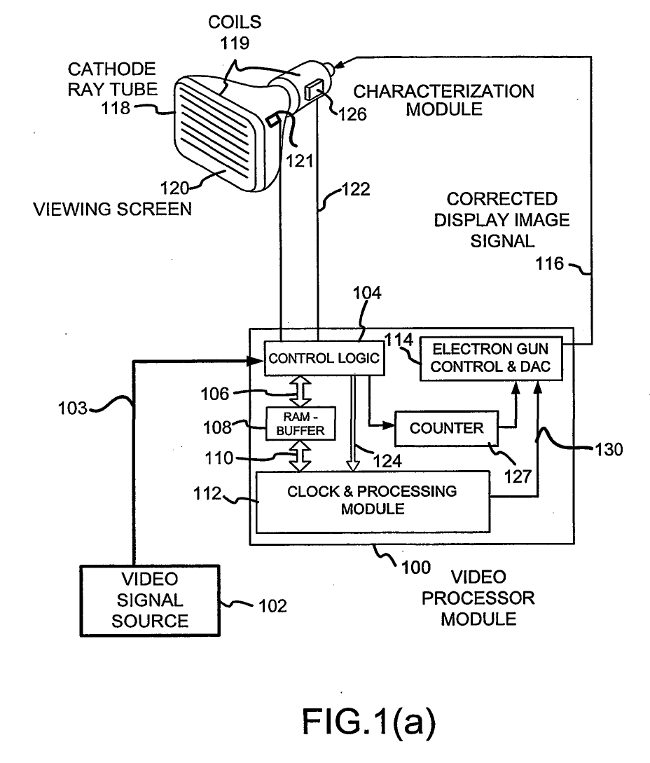

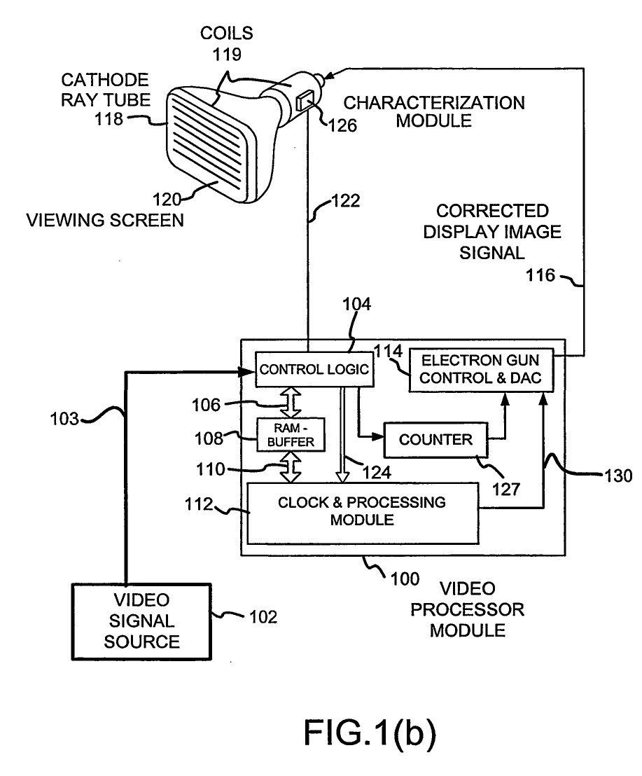

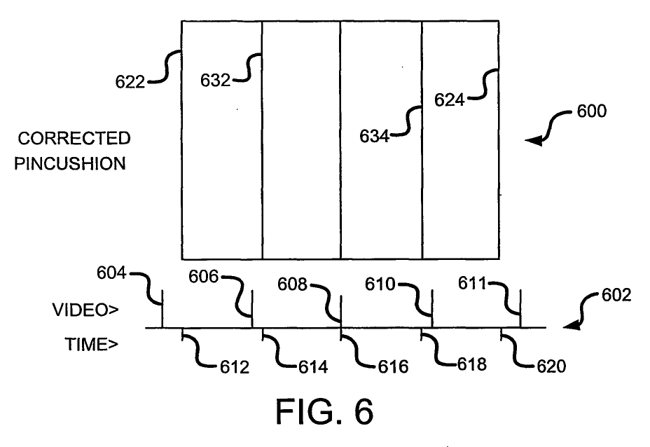

FIG. 1(a) illustrates a system for generating a corrected display image signal 116 to display an image on a screen 120 of a cathode ray tube (CRT) 118 display device. The corrected video signal adjusts the timing and content of image data to correct for errors that would otherwise be caused by the CRT 118. A video processor module 100 maps digitized video signal data to physical screen locations and generates a corrected digital image signal 130 and then an analog display image signal 602 of FIG. 6 to correct for geometric errors introduced by the CRT 118. The mapping may be viewed as occurring in time and physical space across the CRT 118. The video processor module 100 receives a video signal from a video signal source 102, in either digital or analog form. Control logic 104 may contain an analog to digital converter and a multiplexer to send a digitized video signal to RAM buffer 108. A video signal source 102 may be for example, a computer having a microprocessor and a graphics controller card having memory storing digitized video signal data and be able to send a video signal in either a digitized video signal, using a digital visual interface (DVD connection or a more conventional analog video signal using a standard video graphic adapter (VGA) connection. Digitized video signal data includes any binary encoded form of a video signal. Digitized video signal data can be in any format, including, but not limited to, tagged image file format (TIFF) and Joint Photographic Experts Group (JPEG) format. The video signal source 102 might also be a digital video disk (DVD) player. To further illustrate, the video signal source 102 could comprise a video cassette recorder (VCR), or a set top box receiving an analog or a digital video signal from a television network. The video signal source 102 may be a frame buffer storing an entire frame of digitized video signal data Alternatively, the video signal source 102 may store only a single line of digitized video signal data. One skilled in the art will recognize that the video signal source 102 may be able to store any number of lines of data of a digitized video signal.

As shown in FIG. 1(a), in one embodiment of the present invention, the video image processor module 100 is in operable communication with the video signal source 102 via a communication channel 103. Control logic 104 in the video processor module 100 receives a video signal from the video signal source 102 via channel 103. Control logic 104 then processes the video signal. Control logic 104 may contain an analog to digital converter and a multiplexer to first select the video input type and then send the digitized video signal data to a RAM buffer 108. Processing may involve storing parts of the image data in the RAM buffer 108 via connector 106. The RAM buffer 108 stores digitized video signal data and/or any other type of program data necessary for the operation of the processor 100. Connectors 106 provide address data to RAM buffer 108 so the control logic 104 may read or write the image and programming data from RAM buffer 108. Digitized video signal data may also be transmitted from RAM buffer 108 to control logic 104 via connectors 106. A clock and processing module 112 is in operable communication with RAM buffer 108 via connector 110. The clock and processing module 112 is also in operable communication with control logic 104 via connector 124.

Electron gun control module 114 modulates the amplitude and gain of the corrected display image signal 116 that is amplified and applied to the electron guns of the CRT 118. The electron gun control module 114 includes a digital to analog converter (DAC) for converting digital image signal 130 data into an analog display image signal. The electron gun control module 114 operates to convert the digital image signal 130 data to a corrected analog video display image signal 116 by modulating a voltage signal with the digital image signal 130 data.

The CRT 118 has a screen 120 upon which an electron beam is deflected to illuminate addressable illuminating elements on the screen 120. The addressable illuminating elements can be phosphor dots that are excited by the electron beam, and illuminate in response. The arrangement of the illuminating elements on the screen 120 defines picture elements (pixels) that make up a video image that is produced on the screen 120. The CRT 118 has one or more illuminating sources for firing a beam toward the screen 120 to produce an image on the screen 120. For example, in one embodiment, the illuminating source may be a single electron gun that fires an electron beam at the screen 120. In another embodiment, three electron guns fire three electron beams, each beam illuminating either red, green, or blue phosphor dots on the screen 120. Typically, the electron beam or beams are deflected by coils 119 in the CRT 118 which create a magnetic field causing the electron beam to move from left to right and up and down over the screen 120. The electron gun control module 114 generates a video signal output 116 that is amplified and applied to the electron guns to adjust the bias and drive for the electron guns. Adjusting the bias and drive of the electron guns causes the intensity of the electron beam to vary as the beam moves in time across physical locations on the screen 120.

In one embodiment of the invention shown in FIG. 1(a), the control logic 104 receives a signal from a sensor 121 on the CRT 118. The sensor 121 can be an optical sensor sensing the physical screen location of the electron beam. The sensor can also be a yoke current sensor sensing current in the CRT and producing a signal that is a function of beam location. Any other detection device detecting beam screen location can be used for sensor 121. The signal from the sensor 121 has a voltage level that is a function of the physical screen location of the electron beam. The signal from the sensor is used by the control logic 104 to determine an address in image memory of RAM buffer 108 corresponding to the physical screen location. The control logic 104 sends the signal to the characterization module 126, which indexes a correction factor data table to retrieve a value representing the physical screen location. The characterization module 126 sends the value representative of the physical screen location back to the control logic 104, which sends the value to the clock and processing module 112 via connector 124. The clock and processing module 112 uses the value representing the physical screen location to address the RAM buffer 108 and generate a corrected display image data that is sent to the electron gun control circuitry 114. The corrected physical address is sent to the control logic 104, which looks up image data corresponding to the corrected physical address. The control logic 104 retrieves corresponding image information and it is sent to the electron gun control circuitry 114. The electron gun control circuitry 114 uses the image information to modulate a signal to create the corrected display image signal 116. The system in this embodiment can be viewed as a closed loop control system, wherein the beam position is sent to the video processing module 100, which generates the corrected display image signal 116, which is fed back to the CRT 118 causing an adjustment in the intensity of the electron beam.

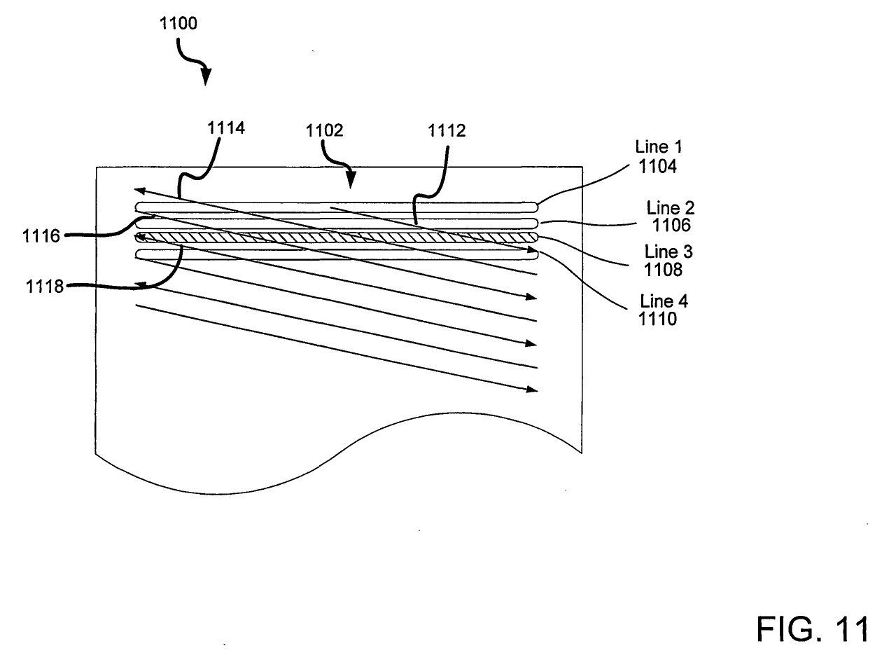

An alternative embodiment is shown in FIG. 11(b) an open loop system in which the characterization module 126 stores values representing pixel time lengths. A pixel time length is the time it takes a beam to move from one pixel to a subsequent pixel on the viewing screen 120. With an elapsed time, the characterization module 126 can look up a time value representing when the next pixel should be displayed to correct for the nonlinearity of the speed of the scanning beam. The characterization module 126 can be constructed and loaded with elapsed time and pixel time information when the display device is manufactured as described in U.S. Pat. No. 6,014,168. The video processing module 100 can receive pixel time information from the characterization module 126 and set a counter module 127 with the pixel time value. The counter module 127 will then count down from the pixel time. In this embodiment, when the counter module 127 gets to zero, the video signal is modulated with the next pixel information.

While the counter module 127 is counting down, the clock and processing module 112 of video processing module 100 retrieves pixel data corresponding to the next pixel at the next physical screen position. The effect of this method is to adjust in time when video signal information changes in accordance with the nonlinearity of the CRT. The nonlinearity of scan time is built into the characterization module 126. The pixel time data provided by the characterization module 126 dictates when the video processing module 100 changes pixel data and transmits a corrected display image signal 116. This embodiment may be viewed as an open loop system, wherein the characterization module 126 stores data that allows for the time position of the scanning beam of the CRT and adjustment of the corrected display image signal 116 to be synchronized.

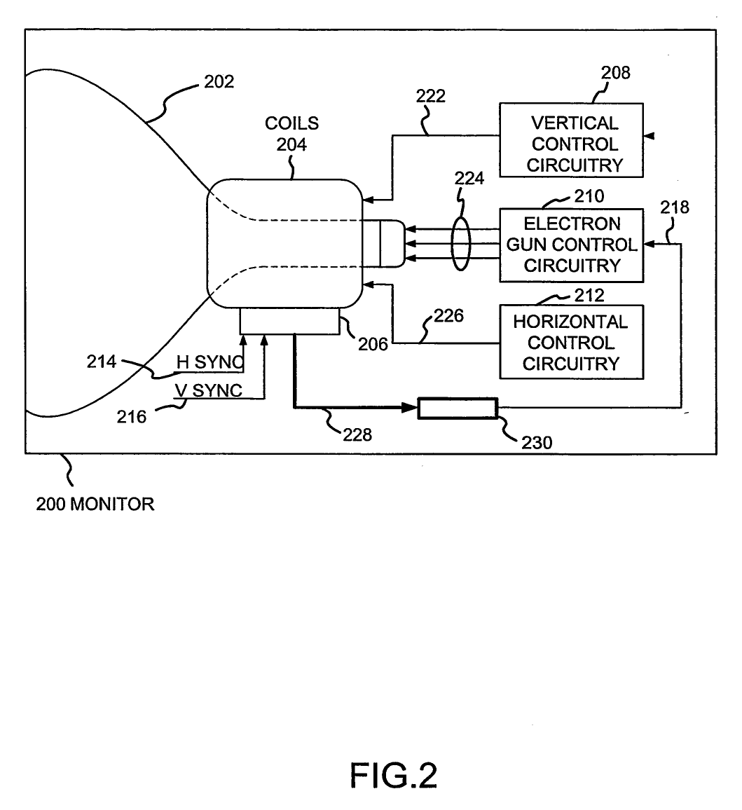

FIG. 2 is a schematic block diagram illustrating a monitor 200 constructed in accordance with an embodiment of the present invention. The monitor 200 includes a cathode ray tube 202, a series of deflection and control windings 204, a characterization module 206 coupled to the coils 204, vertical control circuitry 208, electron gun control circuitry 210, and horizontal control circuitry 212. A horizontal sync signal 214 and a vertical sync signal 216 are applied to characterization module 206. Characterization module 206 has a correction factor data table having CRT characteristic data representative of desired characteristics of the CRT. Characterization module 206 generates an output 228 that is applied to video processor module 230. Using data from the output 228, the video processor module 230 generates a precorrected video image signal 218, which is transmitted to the electron gun control circuitry 210. The vertical control circuitry 208 generates driver signals that are applied by connectors 222 to the coils 204. The electron gun control circuitry 210 generates a video signal 224 that is applied to the electron guns of the cathode ray 210 to project electron beams onto the screen of the CRT for producing an image. The horizontal control circuitry 212 generates a driver signal that is coupled to coils 204 via connectors 226. Characterization module 206 can comprise a nonvolatile memory, a processor, and correction and driver circuitry (not shown).

In operation, the monitor 200 of FIG. 2 has correction factor data stored in a device such as an EEPROM in the characterization module 206. The characterization module produces correction factor signals 228 that are communicated to the video processor module via output 228. The correction factor data stored in the characterization module 206 indicates the distortion characteristics of the particular cathode ray tube 202 that have been derived in a cathode ray tube production facility using a system such as that described in U.S. Pat. No. 6,014,168. The characterization module 206 can also include CRT parametric data, which may be generated using the system described in U.S. Pat. No. 5,216,504, issued to James R. Webb, et al, entitled “Automatic Precision Video Monitor Alignment System,” incorporated herein by reference for all that it teaches and discloses. Various components of the characterization module 206 read the correction factor data and generate screen parameters related to desired specifications for displayed video images. The generated specifications are related to the physical characteristics such as nonlinearity in the speed of the electron beam as it sweeps across the screen. For example, the characterization module 206 may store values representing time required for the electron beam to sweep past each adjacent pixel on the screen.

As also shown in FIG. 2, a correction parameter signal 228 is generated and sent to a video processing module 230. The video processing module uses parameters from the characterization module to generate a corrected video image signal 218, which is transmitted to the electron gun control circuitry 210. The corrected video image signal 218 corrects for distortions in the cathode ray tube by modulating a signal with digital video signal data corresponding to the position of the electron beam to satisfy desired specifications in the cathode ray tube 202.

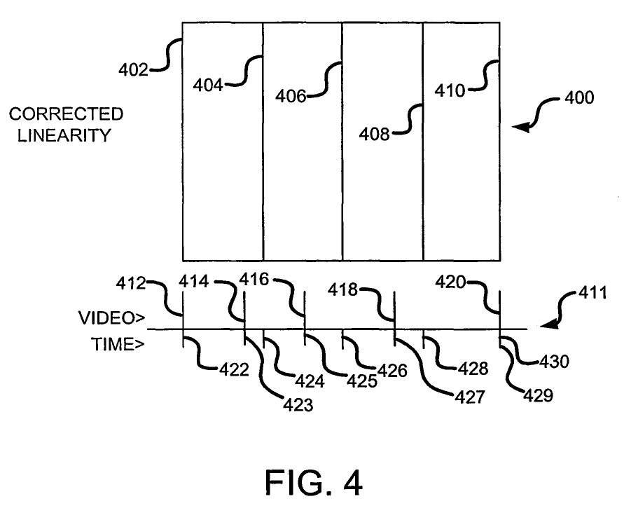

FIG. 4 illustrates a display screen having a precorrected image correcting nonlinearity error in accordance with an embodiment of the present invention. Nonlinearity error is caused by the acceleration or deceleration of the electron beam as is sweeps across the screen, such as the viewing screen 120 of FIG. 1. FIG. 4 depicts a screen 400 having an image displayed on it by a display device, such as cathode ray tube 118 in FIG. 1(a). The image consists of vertical lines 402, 404, 406, 408, and 410 equally spaced from left to right across the screen 400. An illumination source, such as an electron gun in a CRT 118, projects an illuminating beam, such as an electron beam, on the screen 400 to create the image. The electron gun fires an electron beam at the back of the screen 400 which is coated with phosphor dots that are excited and light up in response to being struck by electrons carried by the electron beam. The electron gun is driven by a video signal as represented by a precorrected video signal 411.

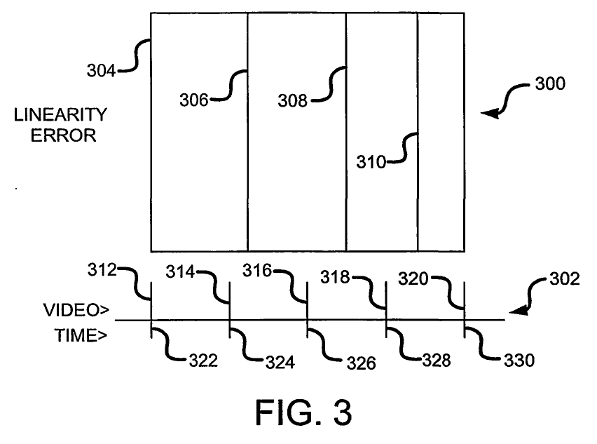

The precorrected video signal includes pulses 412, 414, 416, 418, and 420 being transmitted at times 422, 423, 425, 427, and 429. The video pulses 412, 414, 416, 418, and 420 in the embodiment of FIG. 4 contain pixel information for the image on the screen 400. If the video signal 411 were not precorrected in time, the pulses 412, 414, 416, 418, and 420, would have been located at times 422, 424, 426, 428, and 430. However, as shown in FIG. 3, the electron beam travels at a nonlinear speed across the screen, so at transition times 424, 426, and 428, the video pulses 414, 416, and 418 would have been received too late by the electron gun. The times 412, 414, 416, 418, and 420 at which the pulses 412, 414, 416, 418, and 420 are sent using the system of FIG. 1, adjust for the nonlinearity in the beam scanning speed. The adjustment made to the timing of pulses 412, 414, 416, 418, and 420 is performed using timing data in a correction factor data table in the characterization module 106 of FIG. 1(b). When the CRT is manufactured, characteristic CRT data is stored in the characterization module 106 to adjust the displayed image according to desired CRT specifications. For example, higher or lower values of characteristic beam scanning speed data can be stored in the characterization module to make the image displayed more or less uniform across the screen 400. A video processor module, such as video processor module 100 of FIG. 1, creates and transmits the video signal 411 to the electron gun in the cathode ray tube (CRT). While the embodiment of FIG. 4 depicts a black and white image, it should be understood that the image could be any color in an embodiment using a color CRT. In the color CRT embodiment, there is a video signal for each of three primary colors, red, green, and blue. Each of the video signals in the color CRT embodiment drives one of three electron guns.

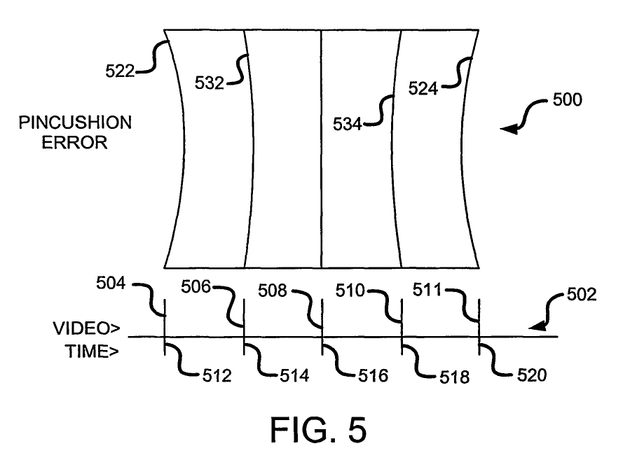

FIG. 6 illustrates a display screen having a precorrected image correcting left/right and inner pin cushioning error in accordance with an embodiment of the present invention. FIG. 6 illustrates a representation of a display screen 600 displaying an image. The image on display screen 600 is created by an electron beam generated by an electron gun in a CRT, such as the CRT 118 in FIG. 1(b). The electron gun receives a video signal represented by a corrected video signal 602 having a series of image data pulses 604, 606, 608, 610, and 611. Image data pulses 604, 606, 608, 610, and 611 are spaced in time relative to equally spaced time units 612, 614, 616, 618, and 620. The corrected video signal 602 is corrected in time by the video processor module 100 in the embodiment of FIG. 1(b). In the embodiment of FIG. 1(b), the video processor module 100 receives time data from the characterization module 126 and uses the time data to adjust when the electron gun control circuitry 114 transmits pixel data. For example, in the middle of the vertical interval, image data pulse 604 is positioned in time prior to time unit 612. The pulse 604 arrives at the electron gun before it would have without precorrection. In response to the earlier receipt of the pulse 604, the electron gun fires a beam that creates a vertical line 622. To correct for inner pin-cushioning error that is shown in FIG. 5, image pulse 606 is positioned in time prior to time unit 614 so that a vertical line 632 is created in the image. The time difference between when pulse 606 is sent and time unit 614 is dictated by correction factor data in the characterization module 126. As was discussed earlier, the correction factor data in characterization module 126 is created by calculating time values associated with physical screen positions on the CRT. Image pulse 608 is transmitted at time 616 to create a vertical line in the middle of the image. By sending image pulse 610 after time 618, which is when pulse 610 would have been sent without precorrection, a vertical line 634 is created to correct for inner pin cushioning that would otherwise result as shown in FIG. 5. Similarly, the image pulse 611 is delayed relative to a time 620 to adjust for the pin cushioning effect of the CRT. By delaying the image pulse 611 a vertical line 624 is created on the right side of screen 600.

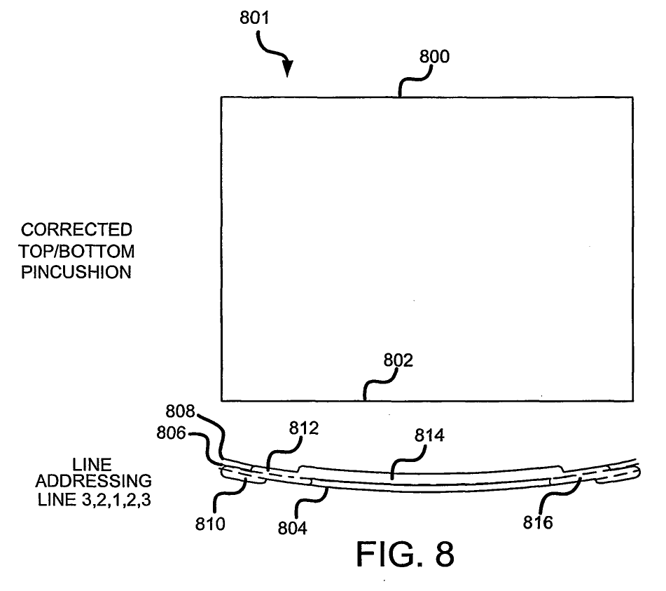

FIG. 8 illustrates a pre-warping solution to top/bottom pin cushioning in accordance with the preferred embodiment of the present invention. FIG. 8 illustrates a CRT screen having a straight line 800 on the top of a screen 801, and a straight line 802 on the bottom of the screen. Below the screen depicted in FIG. 8 is a representation of three scan lines, 804, 806, and 808, used to draw the straight line 800. As the electron beam moves along the scan line 804, information about the electron beam's screen location is transmitted from the CRT to the video processing module. There are several techniques of determining the electron beam location. One way is to attach an optical sensor to the CRT that senses position of the electron beam. Another way is to attach a yoke current sensor to the yoke of the CRT to sense current in the coils of the CRT. The optical sensor or the yoke current sensor can produce a signal that is some function of the beam location. In one embodiment, the signal is proportional to the beam location. In an alternative embodiment, sensors are not used to track the electron beam location, but rather the beam location can be characterized and determined as a function of time and other display control settings. When a sensor is used as in the first embodiment, this may be viewed as a closed loop feedback control system. When sensors are not used but rather the electron beam position is calculated as a function of time and display control settings, this may be viewed as an open loop system. Any other mechanism may be used to determine addressable screen location as the electron beam sweeps across the screen 801. The video processor module 100 receives the electron beam location information from the sensor and uses the information to determine the physical screen location of the beam. The video processor module 100 then uses the physical screen location to retrieve pixel information from an image memory address corresponding to the screen location.

As the electron beam in FIG. 8 scans along scan line 804, the video processor module 100 determines its position as described above, and retrieves image pixel information corresponding to the position. On the leftmost side of scan line 804, pixel information associated with that position is full intensity, typically 255, to indicate a solid line. The full intensity pixel information is used to modulate a video signal which is transmitted to the electron gun. The video signal drives the electron gun to transmit a full intensity beam in the section 810. Similarly, as the electron beam moves along scan line 806, information regarding the beam's screen position is transmitted to the video processor module so that the video processor module can determine the addressable screen location. The electron beam moves through section 812, the corresponding pixel information in image memory is 255, indicating a solid line. The pixel information is used to modulate the video signal that is transmitted to the electron gun such that the electron gun fires at full intensity to draw a solid line in section 812. When scan line 806 moves through section 816, video processor module locates corresponding pixel information in image memory. Along section 816, the corresponding pixel information indicates a value of 255 corresponding to a full intensity beam. The pixel information is used to modulate the video signal communicated to the electron gun so that the electron gun fires a beam at full intensity at section 816 to create a solid visible line. Similarly, as the electron beam travels along scan line 808 position information is communicated to the video processor module 100 so that the video processor module 100 can determine the addressable screen location of the electron beam. When the electron beam enters section 814, the video processor module 100 retrieves corresponding pixel information used to drive the electron beam in that section 814. In the section 814, the pixel information is 255 indicating a solid line. Thus, in the embodiment of FIG. 8, three scan lines are used to draw a single straight line. In order to draw 802, a similar method of beam position determination and pixel information indexing is utilized to turn the electron beam on and off at appropriate times as it travels along a plurality of scan lines.

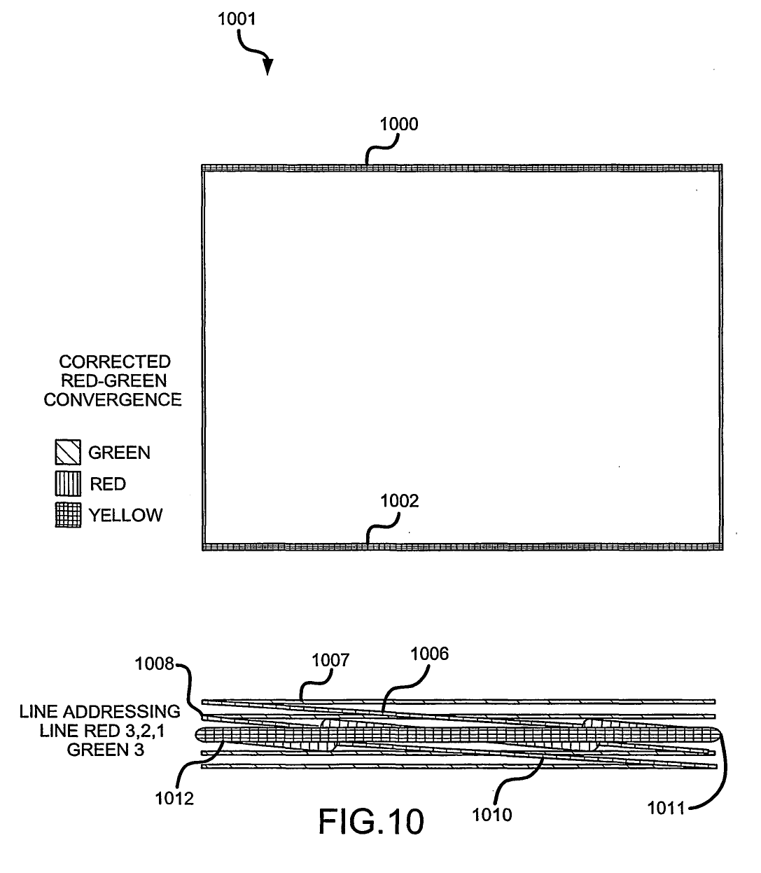

FIG. 10 illustrates a display screen displaying a precorrected image correcting misconvergence in accordance with an embodiment of the present invention. FIG. 10 illustrates a representation of a rectangular screen 1001 on a CRT (such as CRT 118 in FIG. 1(a)) having a top yellow horizontal line 1000 on the top of the screen 1001 and a bottom yellow horizontal line 1002 going across the bottom of the screen 1001. Below the figure of the screen are a series of raster lines 1004. In this illustration, it is assumed that the red raster is misregistered relative to the green raster. Thus a red scan line 1006 sweeps in a diagonal fashion from left to right, whereas a green scan line 1007 sweeps from left to right horizontally. Similarly, red scan line 1008 and red scan line 1010 sweep from left to right diagonally relative to green scan lines. In the embodiment, a green scan line 1011, and sections of red scan line 1006, red scan line 1008, and red scan line 1010, are used to create a yellow image pattern 1012. The green scan line 1011 is parallel to the green scan line 1007 and is hidden from view by yellow image line 1012. The green scan 1011 spans a plurality of pixels at a plurality of screen locations. The yellow image pattern 1012 is a horizontal line created from the green scan line 1011 and sections of red scan lines 1006, 1008, and 1010.

In one embodiment, as red scan lines sweep from left to right, a sensor on the CRT transmits a signal to the video processor module 100. The sensor signal has information defing screen location. The information in the sensor signal can be a function of the beam location as it sweeps across the CRT screen. In the embodiment, the signal is proportional to the beam location. The video processor module 100 can use the signal information to determine an addressable screen location for the red beam 1006. In one embodiment, the video processor module 100 communicates the sensor information to the characterization module to get the addressable screen location. The characterization module can use the sensor information to index a correction factor data table to retrieve the addressable screen location. The characterization module then communicates the addressable screen location to the video processor module 100. The video processor module 100 uses the addressable screen location to retrieve corresponding pixel data from a digitized video signal memory. In an embodiment having color video images on a color screen, there may be three video signal sources (102 of FIG. 1(a)), each storing image data for either the red, green, or blue colors in the image. Alternatively, there may be a single video signal source 102 having three sections of memory, with each section of memory containing red, green, or blue image data.

The yellow horizontal line 1012 is intended to be drawn along the green horizontal raster line 1011. As the red scan line 1006 proceeds from left to right, the video processor module 100 receives screen location information from the CRT sensor and determines a corresponding address in a red image memory (such as video signal source 102 in FIG. 1(a)). The addressable screen location corresponding to the left side of the red scan line 1006 corresponds to an image memory address having red image data of zero, indicating the red electron beam should not fire. When the red scan line 1006 enters pixels spanned by green scan line 1011, image memory address corresponding to that screen location is accessed to retrieve corresponding pixel information. The video processor module 100 uses the corresponding pixel information to create a red video signal which is communicated to the red electron beam. The red video signal instructs the red electron beam to fire at full red intensity level so that yellow is created when the red electron beam converges with the green electron beam. In a similar fashion, as red scan line 1008 sweeps from across the screen 1001 in a diagonal fashion, the video processor module 100 receives the red electron beam's position and determines an addressable screen location. When the addressable screen location of the red scan line 1008 includes pixels spanned by the green scan line 3, the video processor module 100 retrieves non-zero data from image memory corresponding to the addressable screen location. The video processor module 100 uses the non-zero pixel information to create a red video signal that drives the red electron gun at full intensity to create a yellow section of yellow line 1012 along green scan line 1011. As the red scan line 1008 proceeds from green line 3 to raster line 4, the video processor module 100 continues to drive the red electron beam with full intensity. When red scan line 1008 intersects exits the screen locations spanned by green scan line 1011, information in the red image memory is zero. Thus the video processor module 100 creates a red video signal constructing the red electron beam to operate at its lowest intensity. In other words, red scan line 1008 turns off outside the boundaries of the yellow image line 1012. Next red scan line 1010 is used to create the left side of horizontal yellow line 1012. As red scan line 1010 proceeds from left to right, video processor module 100 retrieves pixel information from the red image memory corresponding to the addressable screen location.

Red scan line 1010 begins at the left edge of green scan line 1011 and sweeps in a diagonal fashion across the screen 1001. In the screen locations spanned by green scan line 1001, the corresponding pixel information in red image memory is the full value, which is typically 255 to indicate the full intensity of the red scan beam in that section. The full intensity pixel value is used to modulate the red video signal to the red electron gun, so that the electron beam fires at full intensity as it scans in the region spanned by green scan line. Thus, in the screen locations spanned by green scan line 1011, the red electron gun fires at full intensity. As a result, the red beam converges with the green scan beam to create the yellow-horizontal line 1012. As can be seen, sections of the three red scan lines, 1006, 1008, and 1010, are used to create the yellow horizontal line 1012. By screen locations spanned by the different sections of the red beam gun to corresponding addresses in red image memory, the red beam is turned on at the proper time. The misregistration of the red and green electron guns does not result in misconvergence because the correct image information retrieved from image memory based on where the beam is on the screen 1001. Those skilled in the art will recognize that a minimum buffer size of video image memory data will be required in the video signal source 102 to use more than one section of a raster line to create one image line. This minimum buffer of image data is related to the maximum distortion of the CRT yoke deflection because the maximum distortion determines the number of raster lines required. Testing has shown that an image buffer storing enough image data for two percent of the vertical interval of the screen is generally sufficient.

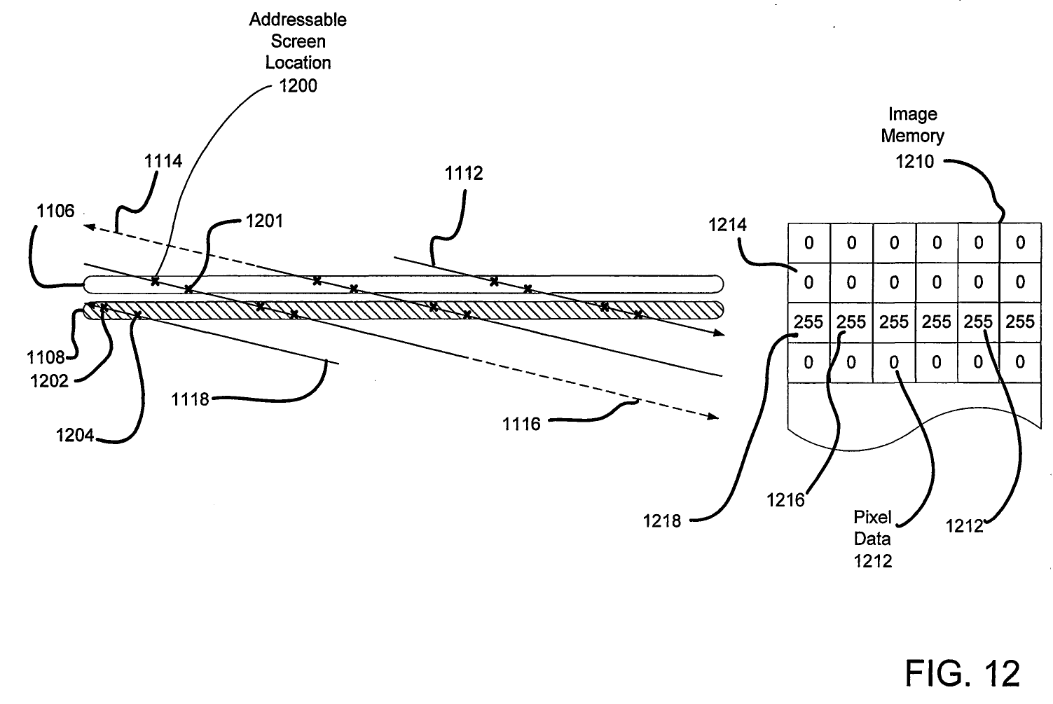

FIG. 11 is a schematic diagram of a portion of a display screen with scanning beam lines drawing an image in an exemplary embodiment of the present invention. A display screen 1100 displays an image 1102 having image lines line 1 (1104), line 2 (1106), line 3 (1108), and line 4 (1110). Line 1(1104) is shown as an invisible line. In other words, there is no visible image pattern along line 1 (1104). Similarly line 2 (1106) is an invisible line having no image pattern. The line 3 (1108) has a visible image pattern in the form of a horizontal line spanning from the left side of the image 1102 to the right side of the image 1102. Line 4 (1110) is another image line having no visible image pattern. Also shown in FIG. 11 are scanning beam lines 1112, 1114, 1116, and 1118. Scanningbeam line 1112 depicts the trajectory of an electron beam being fired from an electron gun (not shown) while moving across the screen. Scanning beam line 1114 illustrates another trajectory of the electron beam sweeping in a diagonal fashion across the screen. Similarly, scanning beam lines 1116 and 1118 depict diagonal trajectories of the electron beam as it sweeps back and forth across the screen. As will be shown in FIG. 12 as scanning beam lines 1112, 1114, 1116, and 1118 sweep back and forth across the screen 1100, they turn on and off depending on where the image 1102 is supposed to be drawn on the screen 1100.

FIG. 12 is a schematic diagram of physical screen locations mapped to corresponding image memory addresses in an exemplary embodiment of the present invention. In FIG. 12 image line 2 (1106), and image line 3 (1108) from FIG. 11 are enlarged. Also shown are the four scan lines 1112, 1114, 1116, and 1118 showing an enlarged view of the trajectory of the electron beam as it passes through image line 2 (1106) and image line 3 (1108). As discussed earlier, the electron beam is modulated to varying intensities depending on where the image is located on the screen. The location of the image on the screen is defined by data representing the image 1102 in an image memory 1210. An addressable screen location 1200 is a physical screen location where the electron beam impacts the screen 1100. Also shown are exemplary addressable screen locations 1202 and 1204. The image memory 1210 stores image pixel data 1212 in addressable locations in memory. Pixel data 1212, 1214, and 1216, are used to modulate a video signal, which drives the electron gun as it fires the electron beam as it scans across the screen 1100.

In FIG. 12, as the electron beam follows scan line 1116 the electron beam passes a physical screen location 1200. Physical screen location 1200 may be thought of as a pixel on the image 1102 being drawn. Inage pixel data 1212 corresponds to the physical screen location 1200 in image memory 1210. Information regarding physical screen location 1200 is transmitted to the video processor module 100 which determines a corresponding address in image memory 1210 having corresponding image data 1212 The video processor module 100 determines the physical screen location 1200 using the information sent to it by accessing the characterization module 126. The video processor module 100 sends information regarding the physical screen location 1200 to the characterization module 126, which uses the information to index into a correction factor data table having physical screen location data. The characterization module 126 sends the physical screen location data to the video processor module 100 which can calculate the physical screen location. The characterization module may send the physical screen location 1200 such that the video processor module 100 does not need to perform any additional calculations. After the video processor module 100 receives the physical screen location 1200, the video processor module 100 can locate a corresponding image memory address.

In FIG. 12, image data 1214 corresponds to the physical screen location 1200. The video processor module 100 determines the address having image data 1214 based on the base address of image memory 1210, the resolution of the image, and the resolution of the screen. The video processor module 100 retrieves image data 1214 and uses it to modulate the video signal that is sent to the electron gun in the CRT. Image data 1214 is 0, meaning that the electron beam should not illuminate physical screen location 1200. Thus, on line 1106 at the physical screen location 1200 the electron beam does not illuminate physical screen location 1200. The electron beam continues along the path defined by the scan line 1116 and when the beam reaches the physical screen location 1201, data related to the physical screen location 1201 is sent to the video processor module 100. The video processor module 100 determines the physical screen location 1200 so that it can look up corresponding image data 1212 in image memory 1210. One unit of image data 1212 may correspond to more than one physical screen location, depending on the resolution of the image and the resolution of the monitor. Image pixel data 1214 is retrieved for physical screen location 1201. The electron beam does not illuminate the screen at the physical location 1202 because the corresponding image data 1214 is zero indicating the lowest intensity beam level. To illustrate further as the electron beam follows scan line 1118 the electron beam passes physical screen location 1204. The video processor module 100 receives information related to the physical screen location 1204 and determines a corresponding address in image memory 1210.

In FIG. 12, the address determined has image data 1216 stored in it. The video processor module 100 uses the image data 1216 to modulate a video signal that is transmitted to the electron gun of the CRT. As shown in the FIG. 12 image data 1216 has a value of 255 indicating the maximum intensity beam level at that physical screen location. Thus the electron beam illuminates the screen at the physical screen location 1204 in response to the video signal received from the video processor module 100. To further illustrate, as the electron beam continues to travel along scan line 1118 it passes the physical screen location 1202. The video processor module 100 determines an address image memory 1210 corresponding to the physical screen location 1202. The physical screen location of 1202 corresponds to the address and memory 1210 holding image data 1218. Image data 1218 has a value of 255 indicating the corresponding physical screen location 1202 should be illuminated. As the electron beam travels along scan line 1112, 1114, 1116, and 1118 image data 1212 is retrieved from image memory 1210 at a manner similar to that described above, whereby the image 1102 or FIG. 11 is produced on the screen 1102.

In the embodiment of FIG. 12, depending on the resolution of the display screen and the resolution of the digital image, there may not be a corresponding image memory address associated with the screen location. The video processor module 100 makes a determination whether a corresponding image memory address having corresponding pixel data exists. If no corresponding image memory location is found, the video processor module 100 has a resolution enhancement module configured to determine pixel data by creating a merged pixel. The merged pixel data is a function of pixel values for pixels adjacent to the screen location. The function of adjacent pixels may include linear interpolation, quadratic interpolation, or any other function that optimizes a specification of the video processor module or the display screen. For example, if processing time is not limited, quadratic interpolation may be practical to yield an image with an optimized resolution or brightness. Processing time may not be a practical concern if the video processor module 100 is implemented as an integrated circuit. On the other hand, if processor time is a concern, the function of adjacent pixels may include setting the merged pixel value equal to the value of an adjacent pixel. Thus, the function used to generate a merged pixel can be varied to improve image quality or optimize the system. Interpolation techniques are discussed in U.S. Pat. No. 5,379,241, issued to Lance Greggain, entitled “Method and Apparatus for Quadratic Interpolation,” which is incorporated herein by reference for all that it teaches and discloses.

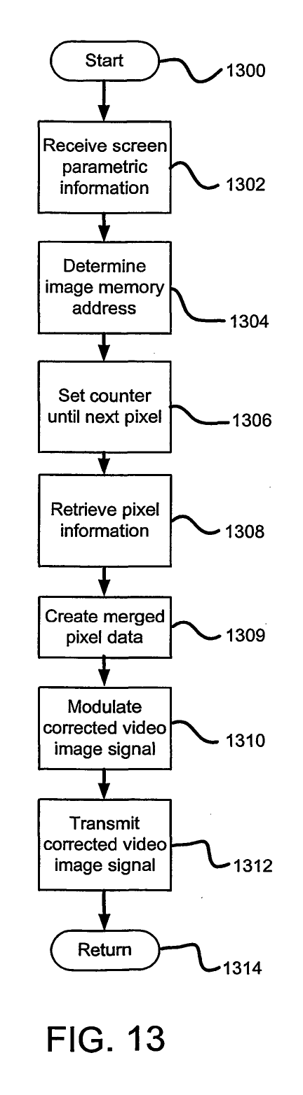

FIG. 13 illustrates a flow control diagram illustrating a method of generating a corrected video image signal. Control initially transfers to start operation 1300 wherein initialization processing begins and the system powers up. Control then transfers to the receiving operation 1302 wherein the video processor module receives parametric screen information from the CRT. The parametric screen information can be a time value indicating a time duration for the electron beam to sweep across a pixel on the screen. The parametric information can also be screen location information that the video processor module can use to determine the location of the electron beam. The parametric information could include any other information regarding desired specifications of the cathode ray tube stored in the characterization module, as described in U.S. Pat. No. 6,014,168. Control then transfers to the setting operation 1306 wherein the video processor module sets a counter module 127 (FIG. 1(b)) with a value representative of the time duration for the electron beam to travel from one screen location to another screen location. The counter then begins counting down and when it reaches zero the counter indicates to send a corrected video image signal. After the counter module is set in operation 1306, control transfers to a determining operation 1304 wherein the video processor module determines an image memory address corresponding to a screen location. The image memory address contains binary encoded pixel data corresponding to the screen location. After the corresponding image memory address is determined in operation 1304, control transfers to the retrieving operation 1308. In the retrieving operation 1308 the pixel data is retrieved from the previously determined image memory address.

Depending on the resolution of the screen and the resolution of the image, there may not be a corresponding image memory address for a screen location. If no corresponding image memory address is found, pixel data for a plurality of pixels adjacent to the screen location are retrieved from image memory in the retrieving operation 1308. Control then transfers to a creating operation 1309 wherein merged pixel data is created for the screen location using the retrieved pixel data for the plurality of adjacent pixels. A resolution enhancement module can be included with the video processor module 100 of FIG. 1(b) and configured to create merged pixel data. Creating a merged pixel preferably involves performing high order interpolation function on the retrieved plurality of pixel data. Any other function of pixel data can be used to create a merged pixel. For example, to save processing time, the function may simply involve setting the merged pixel value equal to the value of a single adjacent pixel. A merged pixel may be viewed as a combination of adjacent pixels. The combination of adjacent pixels may be configured so that resolution and brightness of the image is improved.

Control transfers to a modulating operation 1310 wherein the signal is modulated with the previously retrieved pixel data to generate a corrected video image signal. Modulation may be in response to the counter module reaching zero. After modulating the video image signal in step 1310 control transfers to a transmitting operation 1312 wherein the corrected video image signal is transmitted to the electron gun of the cathode ray tube (CRT). Control then transfers to a returning operation 1314 wherein control is returned to the calling operation.

Two or more DMDs, LCDs or other pixilated displays can be superpositioned optically to form a merged image display using these same methods to correct the resulting viewed image. Applications include ‘heads up’ cockpit and automotive displays, AR goggle displays and projection systems in general. Using multiple overlapping pixel arrays enhances resolution, brightness and image quality in the presence of viewing-perspective induced distortions.

Nearly all displays have the pixel element sized, about 0.5° of arc, for the application, such that the human viewer will be unaware of “seeing” individual elements nor can he distinguish or resolve between the color elements that make up individual pixels. However on nearly every display, viewers can perceive texture and coloration of edges of lines that do not follow the pixel structure. The viewer is far more sensitive to this structure and eliminating or minimizing it requires more than double the resolution.

With offset arrays, the pixel spot size remains the same but the spatial address space quadruples. The display will be capable of producing images with the appearance of a much higher resolution without the display actually physically having it. This is one reason National Television System Committee (NTSC) TV had such acceptance over the years, the image may have only 525 lines vertically per frame with less than 480 visible after blanking and with not much more than that resolution horizontally but the phase space horizontally is far greater. This allows a pixel on adjacent lines to be positioned almost infinitely horizontally (phase space) giving the appearance of continuity to diagonal lines and edges without increasing the video bandwidth, with the exception of computer generated graphics used in weather reports.

Another way of saying this is given a fixed display surface size and viewing distance there will be a limit to the viewers' ability to distinguish between distinct spots (pixels) or pairs of black and white lines. Once this is reached there is little reason to make the spots (pixels) smaller as the observer will “see” only gray. However there is great benefit from being able to position this smallest spot at will with out being limited to a fixed grid spaced the size of the spot. This will allow spots or groups of spots to overlap, minimizing jagged edges to images that do not coincide with the pitch of the grid. Furthermore, should two or more, in the case of color, arrays be superimposed but not exactly registered, Digital Dynamic registration can be made by finding the corrected address for the spots that do coincide so that they may be used to produce an image that is distortion and convergence free.

This method of increasing addressing space may be built into the image receiving display device or the image-generating device such as a graphics card in a PC. This will allow the construction of even higher “resolution” display formats than those used today without increasing the video bandwidth or memory requirements. We may see 4 by 3 images with 4096 by 3072 or 8172 by 6144 “resolution” but really only using and displaying 2048 by 1536 or 1536 by 1152 memory and pixels.

The above specification, examples and data provide a complete description of the manufacture and use of the composition of the invention. Since many embodiments of the invention can be made without departing from the spirit and scope of the invention, the invention resides in the claims hereinafter appended.

The logical operations of the various embodiments of the present invention are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations making up the embodiments of the present invention described herein are referred to variously as operations, structural devices, acts or modules. It will be recognized by one skilled in the art that these operations, structural devices, acts and modules may be implemented in software, in firmware, in special purpose digital logic, and any combination thereof without deviating from the spirit and scope of the present invention as recited within the claims attached hereto.

It will be clear that the present invention is well adapted to attain the ends and advantages mentioned as well as those inherent therein. While a presently preferred embodiment has been described for purposes of this disclosure, various changes and modifications may be made which are well within the scope of the present invention. For example, the characterization module may have rules for processing the video image data. As a further example, in the open loop embodiment, a voltage controlled oscillator may be employed to vary the timing of the transmission of the corrected video signal according to specification data stored in the correction factor data table of the characterization module. Numerous other changes may be made which will readily suggest themselves to those skilled in the art and which are encompassed in the spirit of the invention disclosed and as defined in the appended claims.

What is claimed is:

1. An image display system for displaying video images comprising:
a display device operable to produce an image on a screen, the screen having screen parameters;
an image memory storing pixel information representing a video image or a portion thereof;
a video processor module configured to receive screen information from the display device, the screen information defining a screen parameter, and to map the screen parameter to an address in the image memory corresponding to the screen parameter.

2. The image display system of claim 1 wherein the parameter is a screen location.

3. The image display system of claim 1 wherein the parameter is a time value representative of a time when an illuminating beam will be at a screen location.

4. The image display system of claim 1 wherein the pixel information is used by an electron gun control module for driving an illumination source of the display device to illuminate the screen location.

5. The image display system of claim 1 further comprising a characterization module having a correction factor data table indexable by the screen information to obtain a screen location, the characterization module communicating the screen location to the video processor module.

6. The image display system of claim 1 wherein the display device is a cathode ray tube display.

7. The image display system of claim 6 wherein the display device has a plurality of illumination sources.

8. The image display system of claim 6 wherein the cathode ray tube device further includes an illuminating beam projecting onto the screen at different screen locations, and a sensor sensing a cathode ray tube parameter that is a function of the screen location.

9. The image display system of claim 8 wherein the sensor is a yoke current sensor sensing current in the cathode ray tube.

10. The image display system of claim 5 wherein the correction factor data table is indexable by the screen information to obtain a beam time value representing a future time when the illuminating beam will be positioned at a future location on the screen.

11. The image display system of claim 10 wherein the video processor module further comprises a counter module and control logic, the control logic configured to load the beam time value into the counter module.

12. The image display system of claim 11 wherein the counter module is configured to count down from the beam time value and indicate when a corrected image signal is generated by the video processor module.

13. The image display system of claim 6 wherein the image memory stores an amount of image pixel information sufficient to illuminate a fraction of the screen related to a maximum vertical distortion of a deflection yoke of the cathode ray tube.

14. The image display system of claim 1 further comprising a resolution enhancement module operable to generate information for a merged pixel corresponding to one screen location by manipulating pixel information from a plurality of pixels adjacent to the one screen location.

15. The image display system of claim 14 wherein manipulating includes performing linear interpolation on the information from the plurality of pixels.

16. The image display system of claim 14 wherein manipulating includes performing a quadratic interpolation on the plurality of pixels.

17. A method of producing an aligned image that meets display device specifications comprising steps of:
storing at least one line of video data in a memory module;
retrieving the video data from memory at times associated with the display device specifications;
generating a corrected video image signal;
transmitting the corrected video image signal to the display device;
driving an illumination source using the corrected video signal to illuminate a beam on a screen having illuminating elements to produce the aligned display image.

18. The method of claim 17 wherein retrieving the video data comprises steps of:
indexing a correction factor data table to retrieve a time value representative of time until the beam reaches a screen location; and
loading the time value into a counter configured to count down so that a corrected video image signal can be generated corresponding to the screen location.

19. The method of claim 18 wherein retrieving the video data further comprises steps of:
retrieving a plurality of pixel data for pixels adjacent to a screen location;
creating merged pixel data representing a combination of the plurality of pixel data.

20. A method of displaying a video image comprising:
receiving information from a display device defining an addressable screen location;
retrieving image pixel information from image memory corresponding to the addressable screen location; and
driving an illumination source in the display device using the image pixel information to illuminate the addressable screen location.

21. The method of claim 20 wherein the illumination source projects an illuminating beam at the addressable screen location, the method further comprising a step of:
modulating a voltage signal to create a corrected video image using the image pixel information; and
transmitting the corrected video image at a time associated with a nonlinearity characteristic of the illuminating beam.

22. Computer readable media having computer readable instructions for performing the method of claim 20.
